(19) United States
(12) Patent Application Publication
(10) Pub. No.: US 2025/0191267 A1
(43) Pub. Date: Jun. 12, 2025

(54) PROCESSING VIDEO AND TEXT INPUTS USING CO-TOKENIZATION

(71) Applicant: Google LLC, Mountain View, CA (US)

(72) Inventors: Anthony Jacob Piergiovanni, Nazareth, PA (US); Anelia Angelova, Sunnyvale, CA (US); Kairo Tiere Morton, Pembroke (BM); Michael Sahngwon Ryoo, Rocky Point, NY (US); Weicheng Kuo, Berkeley, CA (US)

(21) Appl. No.: 18/845,295

(22) PCT Filed: Mar. 7, 2023
(86) PCT No.: PCT/US2023/014743

§ 371 Date: Sep. 9, 2024

Related U.S. Application Data
(60) Provisional application No. 63/317,524, filed on Mar. 7, 2022.

(51) Int. Cl. G06T 13/80; G06T 11/60

(52) U.S. Cl. CPC G06T 13/80; G06T 11/60

(57) ABSTRACT

Methods, systems, and apparatus, including computer programs encoded on computer storage media, for processing videos and text using co-tokenization.

### CROSS-REFERENCE TO RELATED APPLICATIONS

This application claims the benefit of priority to U.S. Application Ser. No. 63/317,524, filed Mar. 7, 2022, the entirety of which is incorporated herein by reference.

### BACKGROUND

This specification relates to processing inputs that include video frames using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

### SUMMARY

This specification describes a system implemented as computer programs on one or more computers in one or more locations that processes a multi-modal input that includes both an input text sequence and a sequence of video frames to generate a network output. In particular, the system processes the video and input text sequence using co-tokenization to generate a set of tokens that collectively represent the video and the text and then generates the network output from the tokens using a decoder neural network.

The subject matter described in this specification can be implemented in particular embodiments so as to realize one or more of the following advantages.

This specification describes a technique for generating an output for a multi-modal input that includes both video and text that exhibits state-of-the-art performance on a variety of tasks, e.g., visual question-answering tasks where the input includes text that represents a question about a video and the output is a text sequence that answers the question. Additionally, the described techniques efficiently fuse information from video and text inputs by performing co-tokenization, i.e., by generating a fixed size set of tokens for each video feature that represents information from both the text and the video feature. Because the set of tokens has a fixed size and is generally small relative to the number of feature vectors in a given video feature, the fusion process is computationally efficient, allowing the neural network to exhibit the state-of-the-art performance while minimizing the amount of computational resources, e.g., in terms of FLOPs, consumed to generate a prediction.

In some cases, the system performs iterative refinement of the tokens. Because the iterative refinement updates the relatively small number of tokens rather than the much larger number of visual features of the video, the iterative refinement remains computationally efficient while allowing the system to generate a higher-quality representation that results in improved network outputs.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example video processing system.

FIG. 2 shows an example of the generation of a network output from a network input.

FIG. 3 shows the operation of a learned tokenization neural network block.

FIG. 4 is a flow diagram of an example process for generating a network output.

FIG. 5 is a flow diagram of an example process for processing language features and video stream features to generate a feature representation.

Like reference numbers and designations in the various drawings indicate like elements.

### DETAILED DESCRIPTION

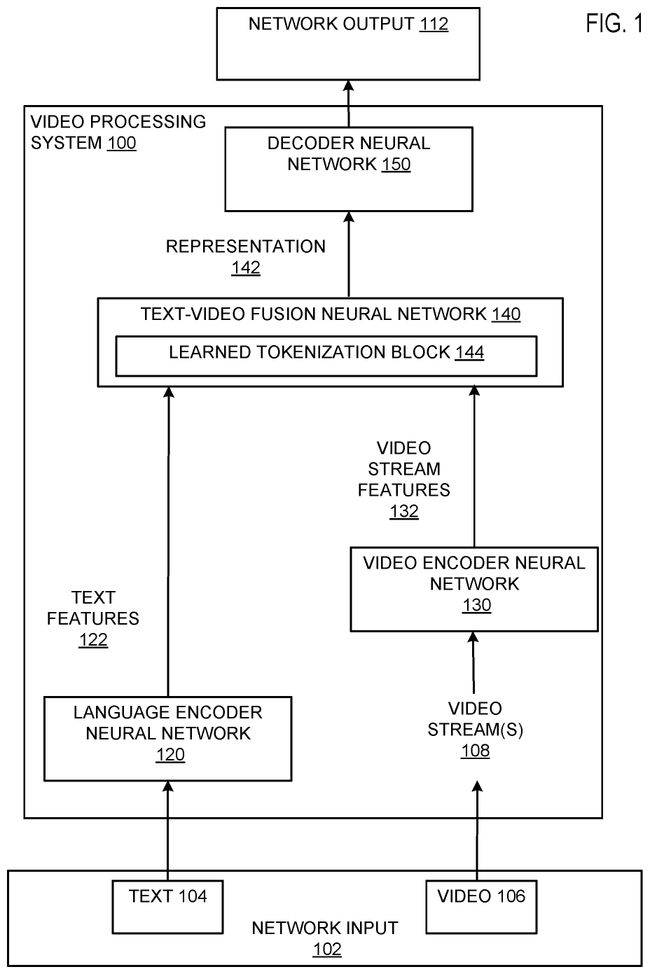

FIG. 1 is a diagram of an example video processing system 100. The video processing system 100 is an example of a system implemented as computer programs on one or more computers in one or more locations, in which the systems, components, and techniques described below can be implemented.

The system 100 receives a multi-modal input 102 that includes both an input text sequence 104 and a sequence of video frames 106 and processes the input 102 to generate a network output 112.

For example, the network output 112 can also be a text sequence.

As a particular example, the input text sequence 104 can represent a question or query about the video sequence and the output text sequence can be an answer to the question or query.

As another particular example, the output text sequence can be a completion of the input text sequence 104 using context from the video sequence.

As another example, the network output 112 can be a classification output that classifies the video sequence into one of a set of categories that are specified in the input text sequence.

As another example, the network output 112 can be a classification output that selects a possible answer from a set of possible answers that is an answer to a question about the video frames 106 that is represented by the input text sequence 104.

As another example, the video frames 106 can be a video of a scene in an environment being interacted with by an agent, e.g., a robot, an autonomous vehicle, or other mechanical agent, the text sequence can define a task to be performed by the agent, and the network output can specify one or more actions to be performed by the agent, e.g., as a natural language instruction or plan for the agent or by specifying a control input for the agent. The system can then control the agent to perform the action.

In particular, to generate the network output 112, the system 100 processes the input text sequence 104 using a language encoder neural network 120 to generate language features 122 that include a sequence of tokens representing the input text sequence.

As used in this specification, a “token” is a vector or other ordered collection of numerical values that has a fixed dimensionality, i.e., the number of values in the ordered collection is constant across different tokens.

The language encoder neural network 120 can be any appropriate neural network 120 that can map a sequence of text to a sequence of tokens. For example, language encoder neural network 120 can be an encoder-only Transformer, an encoder-decoder Transformer, or a recurrent neural network (RNN).

The system 100 generates a set of one or more video streams 108 from the video sequence 106.

Each video stream 108 represents the video sequence 106 at a corresponding space-and-time scale. That is, each video stream 108 includes a set of video frames that have a corresponding spatial resolution (that may be the same as the spatial resolution of the video frames in the video sequence 106 or different from that spatial resolution) and that cover the same time span as the video sequence 106 but at a temporal resolution that may be the same as the temporal resolution of the video sequence 106 or different from the temporal resolution of the video sequence 106.

In some implementations, the set of video streams 108 includes only a single video stream. In these implementations, the system 100 can generate the stream by, e.g., sampling or otherwise selecting a subset of the video frames in the sequence 106.

In some implementations, the set of video streams 108 includes multiple video streams, each with a different combination of spatial and temporal resolution. In these implementations, to generate a given video stream of the multiple video streams, the system can sample from the video sequence 106 to yield an initial sequence having the specified temporal resolution and then downsample the frames in the initial sequence to yield a final sequence having the specified spatial and temporal resolution. As one example, one stream can take many frames at low spatial resolution, while another stream can take few frames at high spatial resolution. Representing the video as multiple streams in this fashion can be useful for many tasks where different inputs, e.g., different questions, can refer to the full video or specific spatial or temporal segments in it, or require the comprehension of events or actions in the video across different duration timeframes, or be very specifically pinpointed in time and space.

For each video stream 108 in the set, the system 100 processes the video stream 108 using a video encoder neural network 130 to generate respective video stream features 132 of the video stream 108 that include a respective video stream feature 132 at each spatial scale in a set of one or more spatial scales. That is, for each spatial scale, the video stream feature 132 at that scale is a feature map having the spatial scale, i.e., having a spatial resolution that matches the spatial scale.

Generally, each video stream feature 132 includes a respective feature map for each frame in the corresponding stream, where each feature map is a grid of feature vectors that covers the corresponding frame with the corresponding spatial scale.

In some implementations, the features 142 for each video stream are single scale features, i.e., the set includes only a single spatial scale. In some other implementations, the features 142 are multi-scale features and the set includes multiple different spatial scales.

When the features 142 are multi-scale, the system 100 can generate the multi-scale features by extracting feature maps that are output by multiple different layers of the video encoder neural network 130, i.e., the feature maps output by one or more intermediate layers of the encoder neural network 130 in addition to the feature map output by the final layer of the encoder neural network 130.

The video encoder neural network 130 can be any appropriate neural network that processes a video stream to generate a feature representation of the video stream. For example, the video encoder neural network 130 can be a convolutional neural network, e.g., a neural network that applies 3D convolutions, e.g., a 3D ResNet or an X3D network, or a neural network that applies 2D convolutions, e.g., a 2D ResNet, but uses temporal pooling to incorporate features across time. As another example, the neural network 130 can be a Transformer, e.g., a vision Transformer neural network or other Transformer neural network adapted to process videos.

The system 100 processes the language features 122 and the respective video stream features 132 of each video stream using a text-video fusion neural network 140 to generate a feature representation 142 of the network input 102 that includes a plurality of tokens.

In particular, for each video stream, the text-video fusion neural network 140 processes the respective video stream features 132 of the video stream and the language features 122 using a first learned tokenization neural network block 144 to map the respective video stream features 132 of the video stream to a respective fixed number of tokens for each spatial scale by using the language features 122 as context. Generally, the fixed number N of tokens for each spatial scale is significantly smaller than the number of feature vectors in the video stream features 132 at that spatial scale. For example, the system can use N=4, 8, or 16 tokens. For a stream that is made up of 16 32×32 feature maps, representing the stream as 8 or 16 tokens results in a representation that is more than 1000× smaller (more compressed) than the video stream features.

Optionally, the text-video fusion neural network 140 can then update the tokens that represent each video stream feature one or more times before generating the feature representation 142.

In particular, the text-video fusion neural network 140 can iteratively refine the tokenization in a computationally efficient manner to improve the feature representation 142.

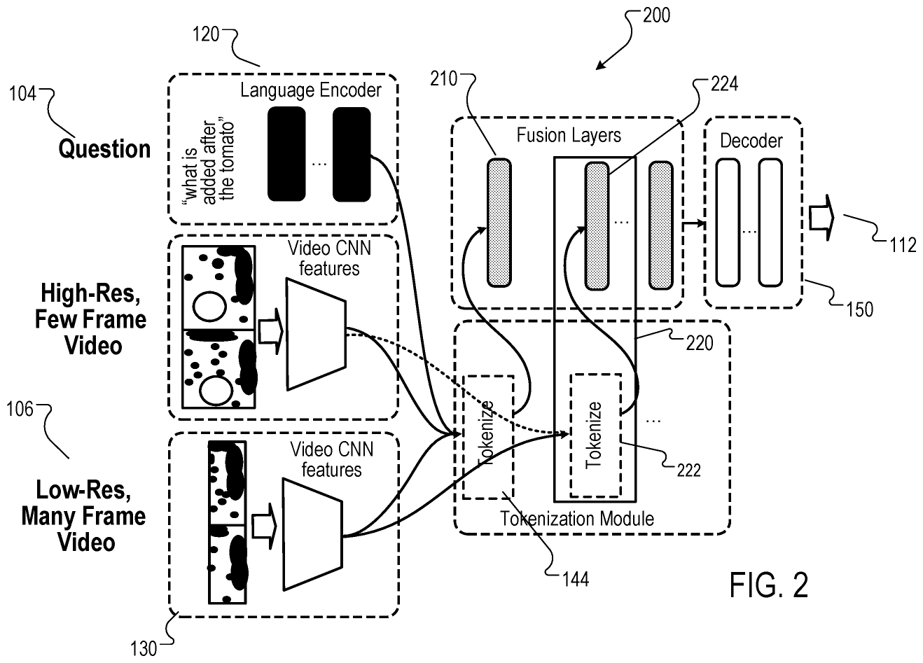

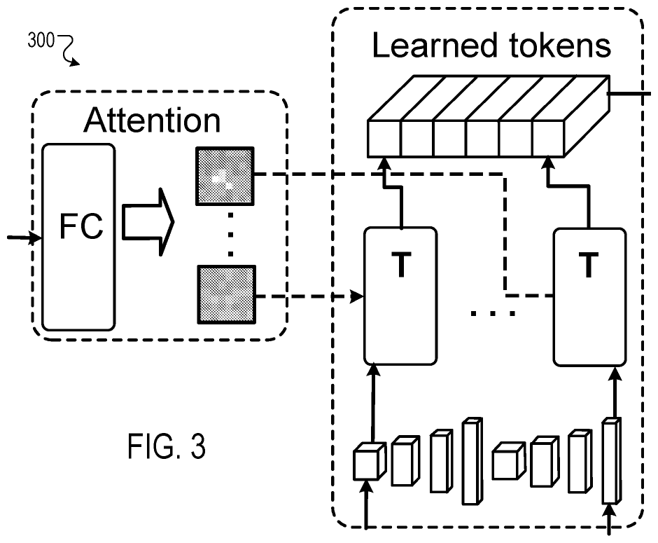

The operations performed by the text-video fusion neural network 140 are described in more detail below with reference to FIGS. 2 and 3.

The system 100 then processes the feature representation 142 using a decoder neural network 150 to generate the network output 112 for the network input 102.

The decoder neural network 150 can have any appropriate architecture that allows the decoder to map a set of tokens to the type of data required by the network output, e.g., a set of scores for a classification output or a sequence of text tokens for a text output.

For example, when the output 112 is a classification output, the decoder neural network 150 can be a multi-layer perceptron (MLP), an encoder-only Transformer, or a recurrent neural network (RNN).

When the output 112 is a text output, the decoder neural network 150 can be an auto-regressive language-based decoder neural network. For example, the decoder neural network 150 can be an auto-regressive recurrent neural network (RNN), an encoder-decoder Transformer with an auto-regressive decoder, or a decoder-only Transformer.

FIG. 2 shows an example of the operation of the system 100 when performing a video-question answering task.

In the example of FIG. 2, the system 100 receives a network input 102 that includes a video sequence 106 and a question “What is added after the tomato?” 104.

In the example of FIG. 2, the system 100 generates, from the video sequence 106, two streams 108, one that is a high-spatial resolution stream with few video frames and another that is a low-spatial resolution stream with many video frames. In practice, a single stream or more than two streams can be used.

The system 100 processes the question 104 using the text encoder neural network 120 to generate language features 122 and processes each of the video streams 108 using the video encoder neural network 130 to generate respective video stream features 132 for each of the video streams 108.

The system 100 then processes the language features 122 and the video stream features 132 for the streams 108 using the audio-video fusion neural network 140 to generate the feature representation 142.

The decoder neural network 150 processes the feature representation 142 to generate the network output 112. In the example of FIG. 2, the network output 112 is a natural language text answer to the input question 104, e.g., “Olive Oil.”

As shown in FIG. 2, the audio-video fusion neural network 140 includes a first learned tokenization neural network block 144 and a first fusion layer (also referred to as “combining layers”) 210.

The neural network 140 also includes a set of token updating neural network blocks 220. Each block 220 includes a respective learned tokenization neural network block 222 and a respective combining layer 224.

To generate the feature representation 142, the neural network 140 first uses the block 144 to map each of the spatial scales for each of the video streams to an initial set of tokens that has a fixed number N of tokens, i.e., so that there are NS total tokens, using the visual features and the language features. That is, S is equal to the number of streams multiplied by the number of spatial scales.

Generally, to generate the N tokens for any spatial scale of any given stream, the block 144 generates, from the respective video stream feature at the spatial scale and the language features, an attention map over the respective video stream feature at the spatial scale for the token. The attention map includes a respective attention weight, i.e., a respective score, for each spatial location in each feature map in the video stream feature. The block 144 then generates the token by applying the attention map to the respective video stream feature at the spatial scale.

The operations performed by the block 144 will be described in more detail below with reference to FIG. 3.

The neural network 140 then generates an initial feature representation of the network input 102 by processing the initial set of tokens using the first combining layer 210.

In particular, to generate the initial representation, the neural network 140 processes the tokens for the spatial scales of the respective video streams, i.e., the NS initial tokens, and the language features 122 using the combining neural network layer 210 to update the tokens for the spatial scales of the respective video streams and update the language features. For example, the combining layer can be a Transformer layer that applies self-attention over the tokens to update the tokens.

Each token updating neural network block 220 receives as input an input feature representation and updates the feature representation to generate an updated feature representation. For the first token updating neural network block 220, the input feature representation is the initial feature representation described above. For any subsequent token updating neural network blocks 220, the input feature representation is the feature representation generated by the preceding token updating neural network block 220.

The neural network 140 then uses the updated feature representation generated by the final token updating network block as the feature representation 142.

To update the input feature representation, for each stream-scale combination, a given token updating network block 220 uses the input feature representation to the block to map the video features for the scale to N tokens. That is, the token updating network block 220 uses the corresponding fusion block 222 to, generate, from the respective video stream feature at the spatial scale and the input feature representation to the block 220 and for each of the tokens, an attention map over the respective video stream feature at the spatial scale for the token, i.e., over the spatial locations in the feature maps of the video stream feature, and then generates an updated token by applying the attention map to the respective video stream feature at the spatial scale.

Generating the attention map will be described in more detail below with reference to FIG. 3.

The token updating network block 220 then processes the input generated from the updated tokens for the video streams at each of the spatial scales and the language features using the corresponding combining neural network layer 224 to update the input feature representation. For example, the input can be a concatenation along the token axis of the updated tokens for each of the video streams at each of the spatial scales and the language features.

The block 220 can either directly use the output of the combining neural network layer 224 as the updated feature representation or can apply one or more additional operations to the output of the combining neural network layer 224. For example, the block 220 can generate the updated feature representation by summing the output of the combining layer 224 with the input feature representation to the block 220.

This approach allows the model to adaptively and iteratively select different visual features, from multiple scales and streams, refining the input to best align with the text. As a result, the generation of the feature representation 142 is highly efficient, due to the iterative tokenization.

FIG. 3 shows the operations performed by a learned tokenization neural network block 300, e.g., the block 144 or one of the blocks 222.

As described above, the text-video fusion neural network 140 can include one or more learned tokenization neural network block. Each learned tokenization neural network block generates a fixed number of tokens N for each spatial scale of each video stream. When there are multiple learned tokenization neural network block, each learned tokenization neural network block after the first learned tokenization neural network block serves to refine the tokens generated by the previous block.

Each tokenization block 300 receives an input representation r. For the first tokenization block 144, the input representation is the language features 122. For each subsequent tokenization block 222, the input representation is the input to the corresponding updating block 220. The input representation generally has shape L×F, where L is the number of features in the input representation r and F is the dimensionality of each feature.

Each block 300 operates independently on each video stream feature to generate the N tokens for the video stream feature. The video stream feature generally have shape T×H×W×C, where T is the number of feature maps in the video stream feature, H×W are the spatial dimensions of the feature map, and C is the dimensionality of each of the feature vectors in each feature map.

To generate the N tokens, the block 300 generally applies a set of learned transformations to the visual stream features and the input representation to generate an attention map. That is, the block 300 uses the input representation as context in order to generate the attention map.

The block 300 then applies the attention map to the video stream feature to generate the N tokens for the video stream feature.

As a particular example, the block 300 can apply a first learned transformation ϕ(r) to r to generate a T×H×W×C feature. For example, the system can use a first fully connected layer (FC) to produce a L×(THW) tensor and then use another fully connected (FC) layer to make the feature have shape C×(THW). The block 300 can then reshape the C×(THW) feature to have shape T×H×W×C.

The block 300 can then add the T×H×W×C feature with the T×H×W×C video stream feature.

Next, the block 300 can apply a second learned transformation ψ(⋅) to transform the sum into a feature with shape T×H×W×N, where N is the number of desired tokens. A softmax function σ is applied over the T×H×W×N feature along the N-axis to generate the respective attention maps for each of the N tokens.

The system then applies the attention maps to the video stream feature to generate the the N tokens. That is, for each token, the block 300 multiplies the attention map for the tokens with the video representation to generate the N tokens. For example, the system can implement this by transposing the T×H×W×N attention map tensor to have shape N×T×H W and then tensor-dot-producing the transposed attention map tensor with the video stream feature while treating T×H×W as the dimensions to contract.

Overall, for a video stream feature fᵥᵢ the operations to generate the N tokens can be expressed as:

$$σ ( ψ ( ϕ ( r ) + {f}_{vi} ) ) \cdot {f}_{vi} .$$

The resulting feature representation will have a shape of N×C, abstracting the entire video stream as a set of N tokens.

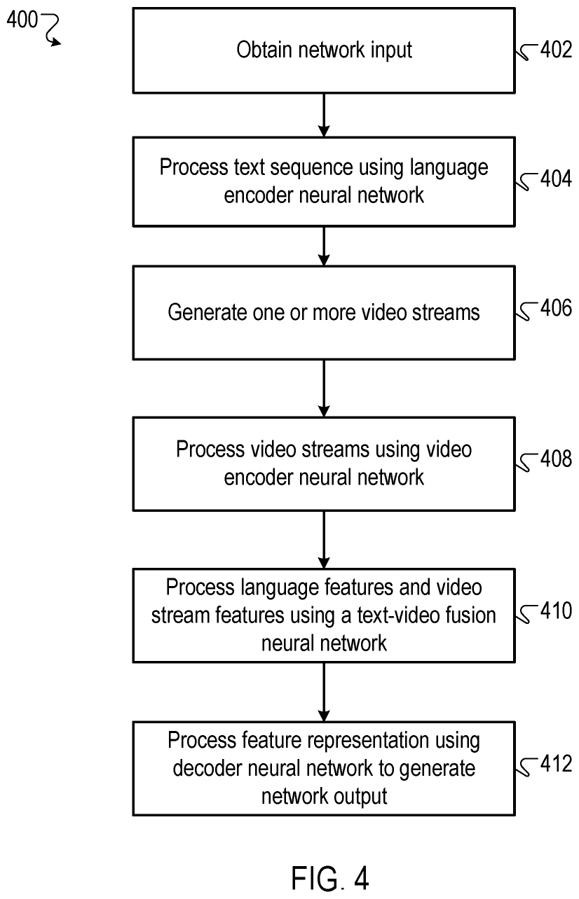

FIG. 4 is a flow diagram of an example process 400 for processing a network input that includes video and text. For convenience, the process 400 will be described as being performed by a system of one or more computers located in one or more locations. For example, a video processing system, e.g., the video processing system 100 depicted in FIG. 1, appropriately programmed in accordance with this specification, can perform the process 400.

The system obtains a network input that includes (i) video sequence that includes a plurality of video frames and (ii) an input text sequence that includes a plurality of text tokens (step 402).

The system processes the input text sequence using a language encoder neural network to generate language features that include a sequence of tokens representing the input text sequence (step 404).

The system generates a set of one or more video streams from the video sequence, each video stream representing the video sequence at a corresponding space-and-time scale (step 406).

For each video stream in the set, the system processes the video stream using a video encoder neural network to generate respective video stream features of the video stream that include a respective video stream feature at each spatial scale in a set of one or more spatial scales (step 408).

The system processes the language features and the respective video stream features of each video stream using a text-video fusion neural network to generate a feature representation of the network input (step 410). As described above, the feature representation is made up of a plurality of tokens and, to generate the feature representation, the system, for each video stream, processes the respective video stream features of the video stream and the language features using a learned tokenization neural network block to map the respective video stream features of the video stream to a respective fixed number of tokens for each spatial scale.

The system processes the feature representation using a decoder neural network to generate a network output for the network input (step 412).

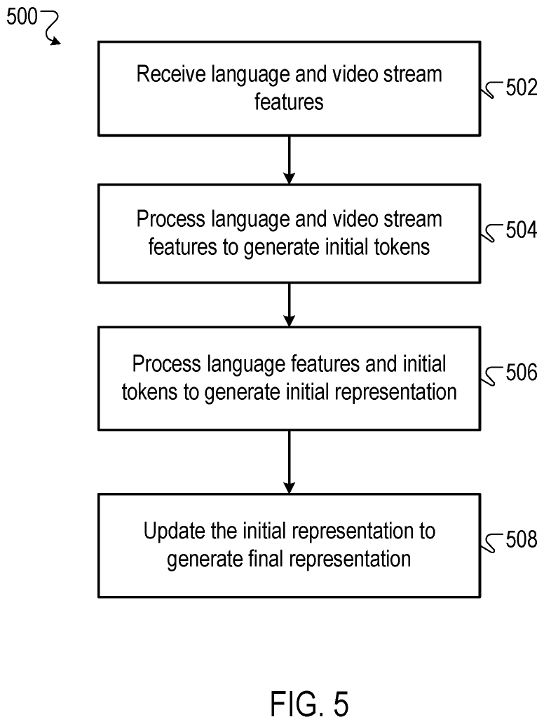

FIG. 5 is a flow diagram of an example process 500 for generating a feature representation from the language and video stream features. For convenience, the process 500 will be described as being performed by a system of one or more computers located in one or more locations. For example, a video processing system, e.g., the video processing system 100 depicted in FIG. 1, appropriately programmed in accordance with this specification, can perform the process 500.

In particular, the process 500 is an example of the operations performed by the text-video fusion neural network during the processing of a network input.

The system receives the language features and respective video stream features of each video stream (step 502).

For each video stream and for each spatial scale, the system processes the respective video stream features of the video stream and the language features using the first learned tokenization neural network block to map the respective video stream features of the video stream to a respective fixed number of tokens for the spatial scale (step 504).

The system processes the language features and the respective tokens for the spatial scales of the video streams using the first combining neural network layer (step 506) to generate an initial feature representation.

In some implementations, the system then updates the initial feature representation to generate the final feature representation (step 508). In particular, the system processes the initial feature representation through a sequence of one or more token updating neural network blocks. As described above, each token updating neural network block receives an input feature representation and processes the input feature representation to update the input feature representation. The system can use the updated feature representation output by the last token updating neural network block as the final feature representation.

Prior to using the text-video fusion neural network 140 and the decoder neural network 150 to perform the machine learning task, a training system trains the text-video fusion neural network 140 and the decoder neural network 150 to perform the task, i.e., to determine trained values of the parameters of the neural networks. For example, the training system can train the neural networks from scratch on training data for the task to minimize a loss function for the task, e.g., a cross-entropy loss, a negative log likelihood loss, and so on using conventional machine learning techniques. As another example, the training system can first pre-train the text-video fusion neural network 140, the decoder neural network 150, or both on an unsupervised or self-supervised objective and then fine-tune the neural networks on the training data for the task. As yet another example, the training system can train the neural networks on both unlabeled data and the training data for the task through semi-supervised learning.

During training, the training system can incorporate any number of techniques to improve the speed, the effectiveness, or both of the training process. For example, the system can use dropout, label smoothing, or both to reduce overfitting. As another example, the system can perform the training using a distributed architecture that trains multiple instances of the neural network in parallel.

Moreover, as described above, the system can first pre-train one or both of the neural networks on a large unsupervised data set through self-supervised or unsupervised learning and then fine-tune the neural networks on task-specific training data to optimize the loss function for the task.

In some implementations, the training system trains the language encoder neural network 120 and the video encoder neural network 130 jointly with the neural networks 140 and 150. In some other implementations, the language encoder neural network 120, the video encoder neural network 130, or both are pre-trained and held fixed during the training of the neural networks 140 and 150.

TABLE 1

| | | TGIF | TGIF Action | TGIF Trans. | | |
|---|---|---|---|---|---|---|
| | | Frame-QA | (What happens | (What happens | | |
| Model | GFLOPs | Single frame | X times?) | after X?) | IVQA | MSRVTTQA |
| Single-frame | — | 24.4 | 0.7 | 1.5 | 8.4 | 7.2 |
| Single-stream | 150 | 21.5 | 8.2 | 9.2 | 14.2 | 24.8 |
| 2-stream | 47 | 24.2 | 8.8 | 9.2 | 14.5 | 24.7 |
| +Transformer | 49 | 24.5 | 9.1 | 10.9 | 14.4 | 25.3 |
| +Tokenization | 40 | 24.7 | 9.7 | 11.6 | 14.9 | 25.5 |
| +Multi-Scale | 41 | 26.2 | 11.5 | 12.2 | 15.2 | 26.2 |
| +Iterative Co-Tok. | 42 | 27.3 | 11.8 | 12.5 | 15.5 | 27.6 |

Table 1 shows the performance in terms of computational efficiency and task performance of various implementations of the described techniques.

In particular, rows of Table 1 describe various architectures and columns of Table 1 describe various performance measurements of the architectures. For example, the “GFLOPs” column indicates how many giga floating operations per second (FLOPs) are required to generate an output for a given input using the corresponding architecture.

The remaining columns indicate accuracies of the various architectures, with each column corresponding to a data set for a task, e.g., video question answering, that is readily obtainable by those skilled in the art according to accuracy measures for those data sets.

The TGIF data set is described in Jang, Y., Song, Y., Yu, Y., Kim, Y., Kim, G.: Tgif-qa: Toward spatio-temporal reasoning in visual question answering. In: CVPR (2017). and explain that these training data sets are known and readily obtainable by those skilled in the art (if that is the case). TGIF Frame-QA Single Frame is a task that asks questions about a single frame within the TGIF data set. TGIF Action (What happens X times?) is task that asks questions about frequency of occurrence of actions in the data set. TGIF Trans. (What happens after X?) is a task that asks questions about the relative order of actions in the data set.

IVQA is a data set of videos and corresponding questions and is described in more detail in Yang, A., Miech, A., Sivic, J., Laptev, I., Schmid, C.: Just ask: Learning to answer questions from millions of narrated videos. In: ICCV (2021).

MSRVTT QA is a data set that has automatically generated questions and answers from text descriptions of videos and is described in more detail in Xu, D., Zhao, Z., Xiao, J., Wu, F., Zhang, H., He, X., Zhuang, Y.: Video question answering via gradually re ned attention over appearance and motion. In: ACM Multimedia.

The various architectures include two baselines: “single frame,” an image-question answering model that answers questions using a single video frame as context and “single stream,” a video-question answering model that answers questions using a single video stream as context.

The various architectures also include variants of the described techniques. For example, “2-stream” refers to a system in which the set of one or more video streams includes a plurality of video streams, “Transformer” refers to a system which has a first combining neural network layer that is a Transformer layer, “Multi-Scale” refers to a system in which the set of one or more spatial scales includes a plurality of different spatial scales, and “Iterative Co-Tok” refers to a system that uses one or more token updating blocks after the first learned tokenization block and combining layer.

In table 1, the ablations are cumulative, e.g. the last row uses 2-stream+Tok+MS+Iterative Co-Tok.

Thus, as can be seen from Table 1, the various components of the system described in this specification each contribute to reducing the GFLOPs required while improving task performance.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, e.g., inference, workloads.

Machine learning models can be implemented and deployed using a machine learning framework, .e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers, the method comprising:
obtaining a network input comprising:
(i) video sequence comprising a plurality of video frames, and
(ii) an input text sequence comprising a plurality of text tokens;
processing the input text sequence using a language encoder neural network to generate language features that comprise a sequence of tokens representing the input text sequence;
generating a set of one or more video streams from the video sequence, each video stream representing the video sequence at a corresponding space-and-time scale;
for each video stream in the set, processing the video stream using a video encoder neural network to generate respective video stream features of the video stream that include a respective video stream feature at each spatial scale in a set of one or more spatial scales;
processing the language features and the respective video stream features of each video stream using a text-video fusion neural network to generate a feature representation of the network input, wherein the feature representation comprises a plurality of tokens, the processing comprising:
for each video stream, processing the respective video stream features of the video stream and the language features using a first learned tokenization neural network block to map the respective video stream features of the video stream to a respective fixed number of tokens for each spatial scale; and
processing the feature representation using a decoder neural network to generate a network output for the network input.

2. The method of claim 1, wherein the network output is an output text sequence.

3. The method of claim 1, wherein the input text sequence represents a question about the video sequence, and wherein the network output is an output text sequence that is a response to the input text sequence.

4. The method of claim 2, wherein the decoder neural network is an auto-regressive language-based decoder neural network.

5. The method of claim 1, wherein the set of one or more video streams includes a plurality of video streams each having a different corresponding space-and-time scale.

6. The method of claim 1, wherein, for each video stream, the set of one or more spatial scales includes a plurality of different spatial scales.

7. The method of claim 1, wherein for each video stream, processing the respective video stream features of the video stream and the language features using a first learned tokenization neural network block to map the respective video stream features of the video stream to a fixed number of tokens comprises, for each spatial scale and for each token:
generating, from the respective video stream feature at the spatial scale and the language features, an attention map over the respective video stream feature at the spatial scale for the token; and
generating the token by applying the attention map to respective video stream feature at the spatial scale.

8. The method of claim 7, wherein processing the language features and the respective video stream features of each video stream using a text-video fusion neural network further comprises:
generating an initial feature representation, comprising:
processing the tokens for the spatial scales of the respective video streams and the language features using a combining neural network layer to update the tokens for the spatial scales of the respective video streams and update the language features.

9. The method of claim 8, wherein combining neural network layer is a Transformer layer.

10. The method of claim 8, wherein processing the network input using the text-video encoding neural network to generate the feature representation of the network input further comprises:
updating the initial feature representation using one or more token updating neural network blocks, wherein each token updating neural network block is configured to update the sets of tokens by performing operations comprising:
receiving an input feature representation;
for each video stream and for each spatial scale and for each token in the fixed number of tokens for the spatial scale:
generating, from the respective video stream feature at the spatial scale and the input feature representation, an attention map over the respective video stream feature at the spatial scale for the token; and
generating an updated token by applying the attention map to the respective video stream feature at the spatial scale.

11. The method of claim 10, wherein the operations further comprise:
processing an input generated from the updated tokens for the video streams at each of the spatial scales and the language features using a combining neural network layer to update the input feature representation.

12. The method of claim 11, wherein the input is a sum of a concatenation of the updated tokens for the video streams and each spatial scales and the language features and the input feature representation.

13. (canceled)

14. One or more non-transitory computer storage media storing instructions that when executed by one or more computers cause the one more computers to perform operations comprising:
obtaining a network input comprising:
(i) video sequence comprising a plurality of video frames, and
(ii) an input text sequence comprising a plurality of text tokens;
processing the input text sequence using a language encoder neural network to generate language features that comprise a sequence of tokens representing the input text sequence;
generating a set of one or more video streams from the video sequence, each video stream representing the video sequence at a corresponding space-and-time scale;
for each video stream in the set, processing the video stream using a video encoder neural network to generate respective video stream features of the video stream that include a respective video stream feature at each spatial scale in a set of one or more spatial scales;
processing the language features and the respective video stream features of each video stream using a text-video fusion neural network to generate a feature representation of the network input, wherein the feature representation comprises a plurality of tokens, the processing comprising:
for each video stream, processing the respective video stream features of the video stream and the language features using a first learned tokenization neural network block to map the respective video stream features of the video stream to a respective fixed number of tokens for each spatial scale; and
processing the feature representation using a decoder neural network to generate a network output for the network input.

15. A system comprising one or more computers and one or more storage devices storing instructions that when executed by the one or more computers cause the one or more computers to perform operations comprising:
obtaining a network input comprising:
(i) video sequence comprising a plurality of video frames, and
(ii) an input text sequence comprising a plurality of text tokens;
processing the input text sequence using a language encoder neural network to generate language features that comprise a sequence of tokens representing the input text sequence;
generating a set of one or more video streams from the video sequence, each video stream representing the video sequence at a corresponding space-and-time scale;
for each video stream in the set, processing the video stream using a video encoder neural network to generate respective video stream features of the video stream that include a respective video stream feature at each spatial scale in a set of one or more spatial scales;
processing the language features and the respective video stream features of each video stream using a text-video fusion neural network to generate a feature representation of the network input, wherein the feature representation comprises a plurality of tokens, the processing comprising:
for each video stream, processing the respective video stream features of the video stream and the language features using a first learned tokenization neural network block to map the respective video stream features of the video stream to a respective fixed number of tokens for each spatial scale; and
processing the feature representation using a decoder neural network to generate a network output for the network input.

16. The system of claim 15, wherein the network output is an output text sequence.

17. The system of claim 15, wherein the input text sequence represents a question about the video sequence, and wherein the network output is an output text sequence that is a response to the input text sequence.

18. The system of claim 16, wherein the decoder neural network is an auto-regressive language-based decoder neural network.

19. The system of claim 15, wherein the set of one or more video streams includes a plurality of video streams each having a different corresponding space-and-time scale.

20. The system of claim 15, wherein, for each video stream, the set of one or more spatial scales includes a plurality of different spatial scales.

21. The system of claim 15, wherein for each video stream, processing the respective video stream features of the video stream and the language features using a first learned tokenization neural network block to map the respective video stream features of the video stream to a fixed number of tokens comprises, for each spatial scale and for each token:
generating, from the respective video stream feature at the spatial scale and the language features, an attention map over the respective video stream feature at the spatial scale for the token; and
generating the token by applying the attention map to respective video stream feature at the spatial scale.
